(19) United States
(12) Patent Application Publication
(10) Pub. No.: US 2014/0100086 A1
(43) Pub. Date: Apr. 10, 2014

(54) CALF STRETCHING DEVICE

(71) Applicant: Andre J. Pagliaro, Newtown, PA (US)

(72) Inventor: Andre J. Pagliaro, Newtown, PA (US)

(21) Appl. No.: 14/014,023

(22) Filed: Aug. 29, 2013

Related U.S. Application Data
(60) Provisional application No. 61/743,229, filed on Aug. 29, 2012.

(51) Int. Cl. A61H 1/02

(52) U.S. Cl. CPC A61H 1/0237
USPC 482/91

(57) ABSTRACT

A calf stretching device that helps to increase flexibility, improve posture, and promote rehabilitation of lower leg injuries. The device generally includes a wedge-shaped central ramp having two contiguous sections of different lengths joined end-to-end to define a triangular ramp. The long section is defined by two planar surfaces inclined together along at a centerline at an outside angle of approximately 210 degrees. A pair of opposing substantially triangular side panels flank the central ramp and protrude outward beyond the long section and short section to align the feet and stabilize the device. A built in adjustable flip-out riser may be included for more ramp inclines. The device seats atop a door frame and can be used In two orientations, one that ramps up at 25-35 degrees and a second at 55-70 degrees.

### CROSS-REFERENCE TO RELATED APPLICATION(S)

The present application derives priority from U.S. Provisional Patent Application No. 61/743,229 filed 29 Aug. 2012.

### BACKGROUND OF THE INVENTION

1. Field of the Invention

The present invention relates to muscle stretching devices and, more particularly, to a calf stretching device that helps to increase flexibility, improve posture, and promote rehabilitation of Achilles tendon injuries, shin splints, calf strains and other lower leg injuries.

2. Description of the Background

Muscle tightness is a very common issue among the general population, and even more prevalent among seniors. Tight calf muscles are uncomfortable in-and-of themselves. Moreover, they can adversely affect gait, balance, and the forces that the lower extremity is subjected to. Tight calf muscles can result in tight hamstrings, which in turn may affect other muscle groups such those associated with the thigh, buttocks, pelvis, and lower back. The pelvic and lower back regions can be easily damaged as a result. The entire body strives to adapt, putting excessive strain on the joints of the spine, hip, knee, foot and ankle.

There is a very well documented association between common painful conditions such as low back pain, pelvic pain, plantar fasciitis, shin splints, and painful debilitating inflammation of the foot. Individuals with diabetic neuropathy ad excessively tight calf muscles have a higher incidence of plantar forefoot ulcers. Alleviating tight calf muscles and maintaining a good strong, flexible calf muscle can dramatically improve the overall health of an individual, as well as the overall quality of life.

While it is possible to stretch the calf muscle using a wall and proper stretching techniques, this wall itself limits the degree that an individual can stretch the calf. In addition, those individuals that have associated foot or ankle condition may find this technique painful to perform. Some people stretch their calf muscles on a stairstep, and use the stair to allow them to lower their heel and more effectively stretch the calf. However, this technique promotes stretching too rapidly, especially if the person fails to maintain proper balance while on the stairs, which can lead to potential injury. Moreover, stairstep stretching does not align the foot. It is important to place the foot in an optimal position in order to get the best stretch possible, but people tend to seek the easiest most comfortable position on a stairstep, which is less than optimal.

There are numerous commercial devices available to assist people who wish to stretch their calf(s). For example, slant boards are simple inclined devices that may include some adjustability. FIG. 1 illustrates a prior art slant board with adjustable incline. A slant board 10 sits within a base 12 and the angle of the slant board 10 can be adjusted by the angle of a supporting strut 13. The sharper the angle, the more the calf muscle is stretched. It is highly recommended that the muscle is stretched slightly each time, and that slowly the person will increase the angle to allow increased stretching, up to the point that it is safe and comfortable.

As with stairsteps, conventional slant boards do not align the foot into the best position for stretching which is desirable. These simple incline hoards are frequently large, heavy, with a limited range of adjustability, and are not economical for the average individual to obtain.

There are also roller-type calf stretchers as shown in FIG. 2, where the foot is locked into a half moon shaped shoe holder. The user leans forward and backward and the calf muscles stretch. This is somewhat effective, but it is not easy to balance while using this stretching device. This can be extremely dangerous for the elderly and/or anyone who lacks good coordination. Moreover, the foot is not in an optimal position to get the best stretch, and the user tends to bend their knee to maintain balance rather than hyperextending it when stretching the calf. This can be very awkward to use and even difficult for elderly individuals and those with lower extremity arthritis or other painful conditions. Thus, compliance with recommended stretching is diminished significantly and therefore individuals may not improve their condition.

What is needed is a sturdy, unitary calf-stretching device that allows the use of a door frame, door, or any wall for support, does not require the user to fight for balance, and aligns the foot and promotes the ability to maintain hyperextension of the knee while stretching the calf to ensure the upper calf muscle is actually being stretched. The confidence gained by such a device promote longer, deeper, and yet more stable and robust calf stretching. The ease of use and the ability for an individual to regulate the force applied to the stretch promotes greater efficacy, efficiency, and compliance with a directed calf-stretching program. In addition, inverting the foot helps to protect various structures in the Mid-Tarsal Joint (MTJ) that are frequently painful and thus decreases pain while stretching. This is a very important factor with successful use of a stretching device.

### SUMMARY OF THE INVENTION

The present invention is an improved calf stretching device that helps to increase flexibility, improve posture, and promote rehabilitation of Achilles tendon injuries, shin splints, calf strains and other lower leg injuries. The calf-stretching device generally includes a unitary wedge-shaped ramp having two contiguous sections of different lengths, including along foot-placement section and a short section, joined end-to-end and bounded on the sides by side panels in a triangle. The long section is further defined by two planar surfaces each serving as a foot rest (left and right) and inclined together along a centerline at an outside angle of approximately 210 degrees. The pair of opposing substantially triangular side panels flank the central ramp and define an open-bottom hollow interior. The side panels protrude outward beyond the long side and short section. A user may stretch their calf by placing a foot atop the long foot-placement section with the calf-stretching device in a first orientation, open-bottom down with side panels braced against the floor so that the long foot-placement section ramps up at 25-35 degrees. Alternatively, the user may stretch their calf by orienting the calf-stretching device in a second position with short section down, side panels braced against the floor, so that the long foot-placement section ramps up at 55-70 degrees.

For additional adjustment, the device may have a built in pivoting riser housed within the hollow interior and pivoted to the side panels. The riser may be pivoted down and braced against the floor so that the long foot-placement section ramps up at an intermediate angle, e.g. 40-53 degrees. The riser is pivotally engaged to the side panels at hinges to provide the additional incremental ramp incline.

The device nests atop a door jam and allows the use the door frame as support for calf-stretching so the user is stable and willing to stretch without fear of falling because of the stability they gain by the anchoring door jam, and use of the door knob for balance. The user does not have to fight for balance, and the device aligns the foot and promotes hyperextension the knee. The confidence and stability gained promotes a longer, deeper, and yet more stable and robust calf stretching.

### BRIEF DESCRIPTION OF THE DRAWINGS

FIG. 1 is a prior art illustration of a conventional slant-board-type calf stretching device.

FIG. 2 is a prior art illustration of a conventional roller-type calf stretching device.

FIG. 3 is a front perspective view of a calf-stretching device 2 in accordance with an embodiment of the invention.

FIG. 4 is a top view of he calf-stretching device 2 of FIG. 1.

FIG. 5 is an enlarged front perspective view (opposite side) of the calf-stretching device 2 of FIG. 3.

FIG. 6(A-C) is a composite view illustrating the various orientations of the calf-stretching device 2 of FIGS. 3-5.

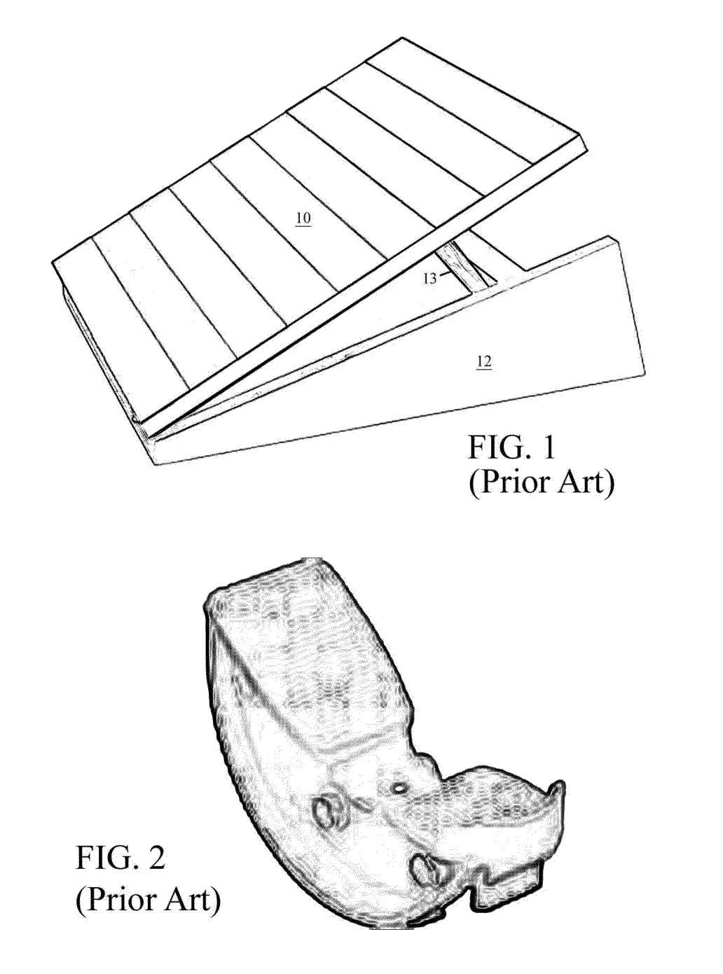

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF THE PREFERRED EMBODIMENTS

The present invention is an improved calf stretching device that helps to increase flexibility, improve posture, and promote rehabilitation of Achilles tendon injuries, shin splints, calf strains and other lower leg injuries.

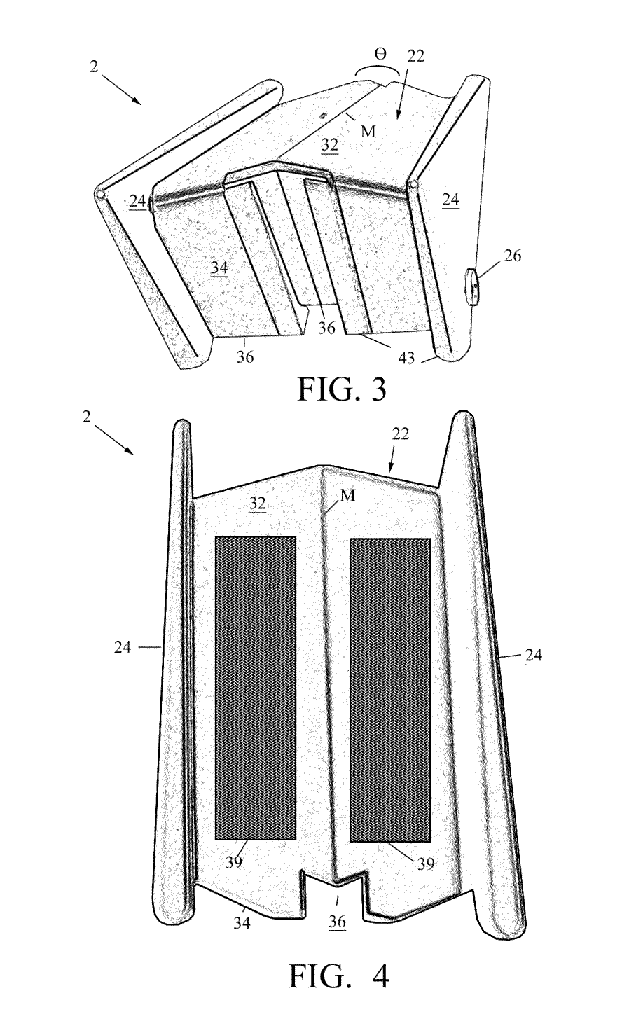

FIG. 3 is a front perspective view of a calf-stretching device 2 in accordance with an embodiment of the invention. The device 2 is generally wedge-shaped, with a ramped body 22 defined by two contiguous sections of different lengths, including along foot-placement section 32 and a shorter section 34, joined end-to-end and flanked by opposing triangular side panels 24. Preferably, the entire ramped body 22 is formed as a unitary hollow injection-molded plastic component open-faced at bottom 36 (obscured underneath) and having a hollow interior.

One skilled in the art will understand that in place of an open-faced at bottom, the bottom may be partially closed by a third contiguous section having a length intermediate to that of the long foot-placement section 32 and a shorter section 34.

The short section 34 joins the long foot-placement section 32 at an angle, preferably a right angle, such that a cross-section taken lengthwise will appear as a right triangle.

The long section 32 further comprises two planar surfaces each defining a foot rest (left and right) and both extending lengthwise from front to rear, joined together along a midline M at an angle θ. Each planar surface of the long foot-placement section 32 is sufficiently wide enough to allow full placement of one of the right or left feet, depending on which foot is being exercised. The planar surfaces of the long foot-placement section 32 peak at midline M and slant downward away from the midline M, such that the left foot will angles toward the left, and the right foot will be angled to the right. The angle θ is calculated to accommodate mild natural “neutral” pronation of the feet, when the right foot is placed atop the inclined left portion of the long section 32 as shown in FIG. 3 and/or the left foot is placed atop the inclined right portion of the long section 32. Angle θ may be, for example, within a range of from 190-250 degrees to provide not less than 5 degree and not more than 25 degree neutral pronation for each foot, is more preferably 200-220 degrees to provide 10-20 degrees neutral pronation, and is most preferably 210 degrees to provide 15 degrees neutral pronation. This slight pronation induces the feet to invert during stretching thus improving foot mechanics and increasing the effectiveness of the stretch exercise.

As seen in FIG. 4, the long section 32 viewed from the top may appear substantially hexagonal with a notch 36 at the fore front. The short section 34 is substantially flat but interrupted by the notch 36, which bisects it, running vertically from top to bottom.

The ramped central body 22 is flanked on opposing sides by opposing triangular side panels 24, the angularity of which generally conforms to that of the ramped central body 22. However, both triangular side panels 24 protrude outward beyond both the long section 32 and short section 34 by a slight margin, e.g., ½-1 inch. Side panels 24 do not protrude at the bottom but rather join flush with the open-faced bottom 36. The protruding margins of side panels 24 on either side of long section 32 work in combination with the pronation angles of long section 32 to seat the feet against the protruding side panels 24 and thereby maintain proper alignment. This self-seats the feet in an optimal position in order to get the best stretch possible, and prevents duck-foot or open-foot stretching. In addition, triangular side panels 24 provide a stable footing for the device 2 in either of two different orientations.

Specifically, with the bottom edges of the triangular side panels 24 seated on the floor, the long section 32 ramps upward from the floor at a first angle within a range of from 25-35 degrees. This way, when the user is just beginning to stretch, the calf-stretching device 2 may be placed in a first orientation open-faced side 36 down against the floor/ground so that the long 25-35 degree incline presents a mild preliminary stretching angle for warming up.

Conversely, with the front edges of the triangular side panels 24 seated on the floor, the long section 32 ramps upward from the floor at a second angle within a range of from 55-70 degrees such that the calf-stretching device 2, after warming up, may be placed in a second orientation, short section 34 down facing the floor/ground so that the long section 32 ramps up at a steeper incline of 55-70 degrees, presenting a sharp stretching angle for more thorough stretching.

As seen in FIG. 4, both surfaces of the long section 32 may be formed with textured, ribbed or striated panels 39, which may be integrally molded or adhesively applied. Panels 39 may occupy a portion or the entirety of both surfaces of the long section 32 in order to promote traction and prevent sliding of the foot during stretching. If adhesively applied, panels 39 are preferably non-skid pads made of a material similar to but not limited to thermoplastic polyurethane (TPU), thermoplastic rubber (TPR) or thermoplastic elastomer (TPE). These are softer thermoplastic compounds that absorb energy preventing scratching. They are tacky and provide stability for the unit not to slide off the door frame while in use.

Similar runners 43 may be applied along the bottom and/or forward edges of the side panels 24 adjacent the open-faced bottom 36, and/or along notch 36, to provide stability for the device 2 so as not to slide while in use. This is also very helpful in carpeted areas where the texture or ribbing will engage the carpet.

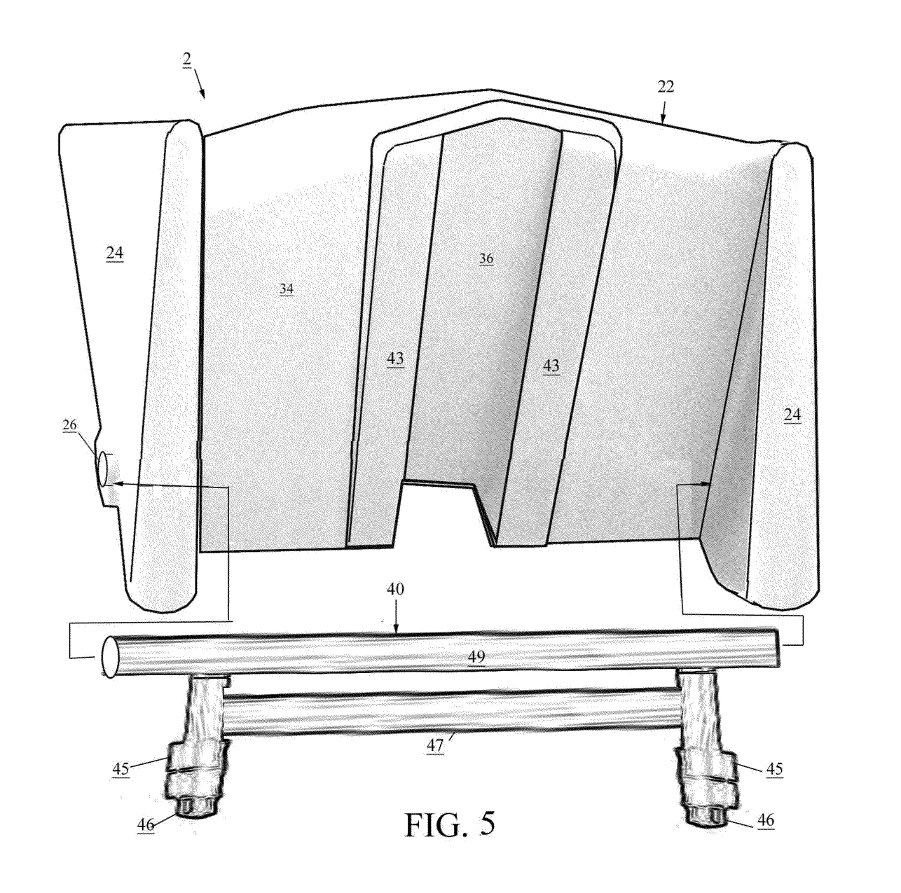

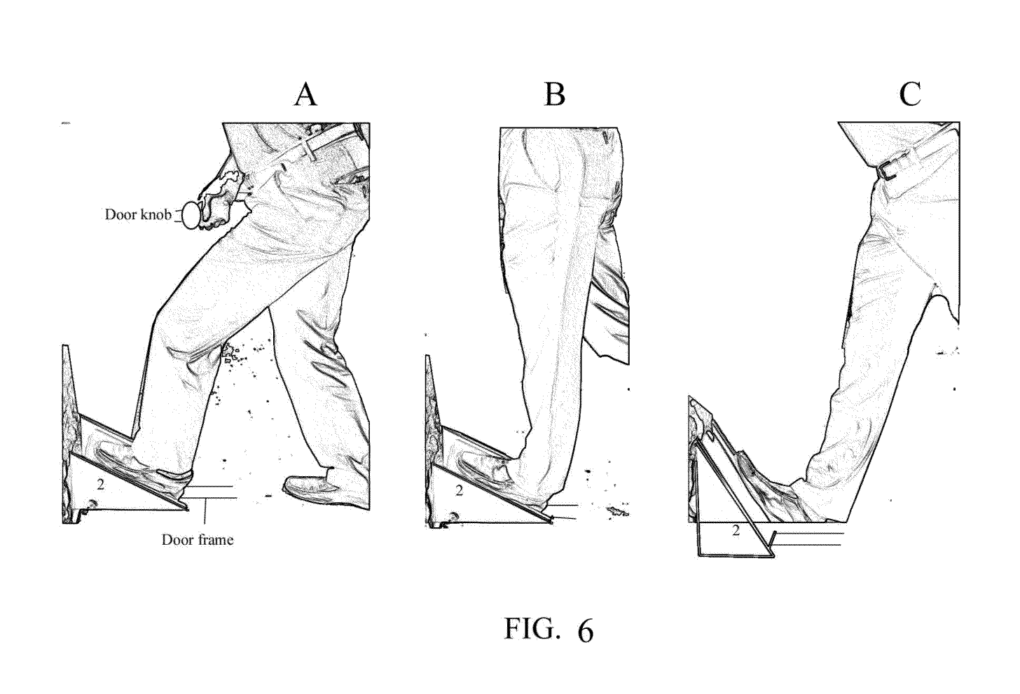

FIG. 5 is an enlarged front perspective view (opposite side) of the calf-stretching device 2 of FIG. 3, detailing the notch 36. The notch 36 runs top-to-bottom vertically along the short section 34 and bisects it. The notch 36 is dimensioned to be wide enough and deep enough to fully seat a standard door jam when placed inside a standard door frame. Notch 36 may be within a range of from 2-3″ wide and 1″ deep. The notch 36 provides device 2 with an anchor vis-a-vis the door jam, allowing the door jam to nestle into notch 36 lengthwise and hold the device 2 against the door stop while in use.

For additional adjustment, the device 2 includes a pivoting riser 40, pivotally engaged to the side panels at hinges 26 to provide one or more additional ramp inclines. Riser 40 seats in a stowed position within the hollow interior of ramp body 22. Riser 40 comprises a main axle 49 rotatably inserted into hinges 26, which may be simple reinforced circular apertures through side panels 24. Two spaced legs 46 protrude downward and may be reinforced by one or more additional cross-beams 49. When the riser 40 is flipped out, the legs 46 protrude downward below the side panels 24 by an additional extent to increase the height of the device 2, thus increasing the angle from the original 25-35 degrees. The riser 40 preferably raises the long foot-placement section 32 up at the fore front sufficiently to present an intermediate incline angle, e.g. 40-53 degrees.

One skilled in the art recognize that riser 40 may be positionable in multiple different positions and locked in place to achieve incremental increases in incline of between 5 degrees and 15 degrees, with 10 degrees being optimal. Alternately, riser 40 may have optional segmented telescoping legs similar to a camera tripod's and continuously extendable to multiple different lengths, again locked in place by clamps 45 (shown in FIG. 5) to achieve continuous variable inclines. In all such cases riser 40 will allow the user to vary the degree of stretch to intermediate inclines falling between the basic first and second orientations described above. As the user progresses, they may increase the angle, and thus increase the possible stretch.

FIG. 6(A-C) is a composite view illustrating the various uses of the calf-stretching device 2 of FIGS. 3-5. In FIG. 6(A) the user is just beginning to stretch with the calf-stretching device 2 placed in a first position intermediate side 36 down against the floor/ground so that the long section 32 ramps up at 25-35 degrees, presenting a mild preliminary stretching angle for warming up. Note the user steps onto the device with knee bent. In FIG. 6(B) as the user shifts their weight onto the device 2 it promotes proper foot alignment which, in combination with the neutral pronation also promotes hyperextension of the knee. The long section 32 ramps up at 25-35 degrees, presenting a mild preliminary stretching angle for warming up. After warming up, as shown at FIG. 6(C), the user flips the device 2 to its second position short section 34 down against the floor/ground so that the long section 32 ramps up at 55-70 degrees, presenting a sharp stretching angle for more thorough stretching. Further inclines may be had by flipping out the adjustable stand 40.

It should now be apparent that device 2 is unique in that it allows the comfortable use a door frame as an anchor and door/knob as hand-support for calf-stretching so the user is stable and willing to stretch without fear of fatting because of the stability they gain by the use of the door stop.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

1. A calf stretching device, comprising:
a wedge-shaped central ramp having at least two contiguous sections of different lengths, including a long section, and a short section, joined end-to-end in a ramp, said long section further comprising two planar surfaces each defining a foot rest and inclined at an angle along a centerline running lengthwise along an entirety of said long section; and
a pair of opposing substantially triangular side panels flanking said central ramp, said side panels protruding outward beyond said long section and short section.

2. The calf stretching device of claim 1, wherein said long section comprises two planar surfaces joined at an outside angle θ within a range of from 190-250 degrees.

3. The calf stretching device of claim 1, wherein said long section comprises two planar surfaces joined at an outside angle θ within a range of from 200-220 degrees.

4. The calf stretching device of claim 1, wherein said long section comprises two planar surfaces joined at an outside angle θ of 210 degrees.

5. The calf stretching device of claim 1, formed from unitary hollow-molded plastic.

6. The calf stretching device of claim 1, wherein said short section is defined by a notch that bisects it from top to bottom.

7. The calf stretching device of claim 6, wherein said notch is three-sided

8. The calf stretching device of claim 1, wherein said triangular side panels are angled in conformance with the central ramp and define right triangles.

9. The calf stretching device of claim 1, wherein said triangular side panels are angled in conformance with the central ramp, are shaped as right triangles, and protrude outward beyond both the long section and short section by a slight margin.

10. The calf stretching device of claim 9, wherein said ramped body comprises an open-faced bottom, a hollow interior, and said triangular side panels are flush with said bottom.

11. The calf stretching device of claim 9, wherein said margin is within a range of from ½ to 1″.

12. The calf stretching device of claim 1, wherein a user may stretch their calf by placing the calf-stretching device in a first orientation on a floor with long section inclined up from said floor within a range of from 25-35 degrees, and placing a foot atop said long section.

13. The calf stretching device of claim 12, wherein a user may stretch their calf by placing the calf-stretching device in a second orientation on a floor with long section inclined up from said floor within a range of from 55-70 degrees, and placing a foot atop said long section.

14. The calf stretching device of claim 10, further comprising a riser pivotally engaged to said side panels and pivotal to a stowed position inside said hollow interior.

15. The calf stretching device of claim 14, wherein said pivoting riser is held captive in apertures in said opposing side panels.

16. A calf stretching device, comprising:
a wedge-shaped central ramp having at least two contiguous sections of different lengths, including a long section and a short section joined end-to-end in a right triangle, said long section further comprising two planar surfaces each defining a foot rest and inclined at an angle along a centerline running lengthwise said short section to said intermediate side; and
a pair of opposing substantially triangular side panels flanking said central ramp and defining a hollow interior with open-bottom, said side panels protruding outward beyond said long section and short section; and
a pivoting riser hinged at said side panels and pivotal to a stowed position inside said hollow interior.

17. The calf stretching device of claim 16, wherein said long section comprises two planar surfaces joined at an outside angle θ within a range of from 190-250 degrees.

18. The calf stretching device of claim 16, wherein said long section comprises two planar surfaces joined at an outside angle θ within a range of from 200-220 degrees.

19. The calf stretching device of claim 16, wherein said long section comprises two planar surfaces joined at an outside angle θ of 210 degrees.

20. The calf stretching device of claim 16, formed from unitary hollow-molded plastic.

21. The calf stretching device of claim 16, wherein said short section is defined by a notch that bisects it from top to bottom.

22. The calf stretching, device of claim 21, wherein said notch is three-sided

23. The calf stretching device of claim 16, wherein said triangular side panels are angled in conformance with the ramped central body but protrude outward beyond both the long section and short section by a slight margin.

24. The calf stretching device of claim 23, wherein said margin is within a range of from ½ to 1″.

25. The calf stretching device of claim 16, wherein a user may stretch their calf by placing a foot atop said long section with the calf-stretching device in a first position with open-faced bottom facing the ground so that the long section ramps up at 25-35 degrees.

26. The calf stretching device of claim 25, wherein a user may stretch their calf by placing a foot atop said long section with the calf-stretching device in a second position with short section resting against the ground so that the tong section ramps up at 55-70 degrees.

27. The calf stretching device of claim 14, wherein said pivoting riser is held captive within opposing apertures in said opposing side panels.
